(19) United States
(12) Patent Application Publication
(10) Pub. No.: US 2005/0177559 A1
(43) Pub. Date: Aug. 11, 2005

(54) Information leakage source identifying method

(76) Inventor: Kazuo Nemoto, Kawasaki-shi (JP)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/042,762

(22) Filed: Jan. 25, 2005

(30) Foreign Application Priority Data
Feb. 3, 2004 (JP) 2004-026701

(51) Int. Cl. G06F 7/00

(52) U.S. Cl. 707/3

(57) ABSTRACT

A leakage source can be identified when personal information is leaked to unauthorized entities. A search request section acquires a request to search a database together with information to identify the search requester. A search processing section searches the database and mixes dummy data into the search result. A search result section outputs the search result into which the dummy data is mixed to the search requester. A use history creates information indicating a relationship between information identifying the search requester and the dummy data mixed into the search result. Another section controls the search result acquiring section, the search processing section, the search result outputting section and the use history creating section.

### FIELD OF THE INVENTION

The present invention relates to a system, method and program for identifying a source of information leakage such as personal information.

### BACKGROUND ART

Today, many companies retain personal information such as customer data. It is natural that companies retain personal information for reasons of business necessity. However, if that information is not properly controlled by the company, problems may arise. For example, many cases of personal information being leaked due to poor control of such information have been reported. Each time such a case is reported, consumers feel anxious about their personal information that is controlled by companies. Recently, the public at large has become more sensitive to how personal information is dealt with.

In view of this situation, the Act for Protection of Computer Processed Personal Data held by Administrative Organs was legislated in May 2003. This Act prohibits providing personal information to a third party without that person's consent. A penalty is applied to a company that violates the provisions of the Act. That is, a company's liability for mishandling personal information has been explicitly written into the law.

More and more companies are outsourcing roster management work of customer data to external companies, instead of managing the roster in-house. For example, computer entry of personal information collected in one country may be outsourced to a company in another country where labor costs are lower. Roster management work is monotonous and the trend of such outsourcing is fixed. The cost to an outsourcing company is relatively low, and, thus, it is difficult, in reality, to control the ethics of workers at the outsourced company.

Therefore, leakage of personal information is expected to continue to increase and may become a serious social problem. A solution to the problem of personal information leakage has being sought (see, for example, Japanese Published Patent Application 2002-183367). However, a problem with the technology disclosed therein is that it only reveals leakage of personal information from a company but cannot show who has leaked the information.

Therefore, the system disclosed therein is not sufficient to improve the ethics of the workers handling the personal information. The system disclosed cannot motivate companies to use the technology because it only identifies the company that has leaked the information.

Furthermore, the system disclosed therein only reveals the fact that personal information has been leaked but not how the leakage occurred. A leakage process could be analyzed through discussions between a personal information protection service provider and the company which is the source of information leakage. However, such discussions are likely to take a considerable amount of time. Thus, ex post facto processing for a determination of the cause of leakage and improvement for preventing leakage cannot be done quickly.

### SUMMARY OF THE INVENTION

The present invention solves these technical problems. An object of the present invention is to allow the source (route) of leakage of personal information to be identified when such leakage occurs.

Another object of the present invention is to allow the source of personal information leakage to be identified, thereby meeting the desire from companies to improve the ethics of their workers and strictly control information.

Yet another object of the present invention is to allow the source of personal information leakage to be identified, thereby quickly performing actions after the information leakage.

To achieve these objects, the present invention allows information to be retained which makes it possible to follow an association relationship between a person who has performed a database search and dummy data that has been presented to that person. In particular, a first database access monitoring apparatus of the present invention includes a search request acquiring section together with information identifying a search requester; a search processing section for searching the database based on the search request acquired by the search request acquiring section and mixing dummy data into the search result; a use history creating section for creating information indicating an association relationship between the information identifying the search requester which has been acquired by the search request acquiring section and the dummy data mixed into the search result by the search processing section; and a search result outputting section for outputting to the search requester the search result into which the dummy data has been mixed by the search processing section.

According to the present invention, the database may be a dedicated database for personal information. In that case, a second database access monitoring apparatus of the present invention includes a search request acquiring section to search a personal information database together with information identifying a search requester; a search processing section for searching the personal information database based on the search request acquired by the search request acquiring section and adding one of a plurality of dummy data items created in advance for a dummy person to the search result; a use history creating section for creating information indicating an association relationship between the information identifying the search requester acquired by the search request acquiring section and the one dummy data item added by the search processing section; and a search result outputting section for outputting to the search requester the search result to which the one dummy data item has been added by the search processing section.

The present invention may be viewed as an information leakage source identifying system for identifying the source of information leakage if such leakage occurs. In that case, an information leakage source identifying system of the present invention includes a database access monitoring section for mixing dummy data into the result of searching a database and outputting to a search requester the search result in which the dummy data is mixed; a use history storing section for storing information indicating an association relationship between information identifying the search requester and the dummy data mixed into the search result by the database access monitoring section; and a verification section for referring to the use history storing section to output the information identifying the search requester associated with specific dummy data.

The present invention may also be viewed as a method for retaining information that allows an association between a person who has searched a database and dummy data that has been presented to that person to be followed later. In that case, a database access monitoring method of the present invention causes a computer to monitor accesses to a database, which includes the steps of: acquiring a request to search the database together with information identifying a search requester; searching the database based on the search request; mixing dummy data into the result of searching the database; storing information indicating an association relationship between the information identifying the search requester and the dummy data mixed into the search result in a predetermined storage device; and outputting to the search requester the search result into which the dummy data is mixed.

The present invention may also be viewed as a method for identifying the source of information leakage if such leakage occurs. In that case, an information leakage source identifying method of the present invention includes the steps of: mixing dummy data into the result of the searching a database and outputting to a search requester the search result into which the dummy data is mixed; storing information indicating an association relationship between the information identifying the search requester and the dummy data mixed into the search result in a predetermined storage device; and identifying the information identifying the search requester associated with specific dummy data based on the stored information indicating the association relationship.

The present invention may be viewed as a program for causing a computer to implement predetermined functions. In that case, a program of the present invention causes a computer to implement the functions of: acquiring a request to search a database together with information identifying a search requester; searching the database based on the acquired search request as well as mixing dummy data into the search result; and creating information indicting an association relationship between the information identifying the search requester and the dummy data mixed into the search result.

### BRIEF DESCRIPTION OF THE DRAWINGS

For a more complete understanding of the present invention and for further advantages thereof, reference is now made to the following Detailed Description taken in conjunction with the accompanying drawings, in which:

FIG. 1 shows a general view of a first model to which the present invention is applied;

FIG. 2 shows an example of data in a dummy customer DB used in the first model to which the present invention is applied;

FIG. 3 shows data in a table used for building a dummy customer DB in the first model;

FIG. 4 shows data in a table used for building the dummy customer DB in the first model;

FIG. 5 shows an example of a use history output in the first model;

FIG. 6 shows a general view of a second model to which the present invention is applied;

FIG. 7 shows an example of data in a dummy customer DB used in the second model to which the present invention is applied;

FIG. 8 shows an example of a use history output in the second model to which the present embodiment is applied;

FIG. 9 is a diagram for illustrating dispersion of profiles in dummy data in the present embodiment;

FIG. 10 is a block diagram showing a hardware configuration of a DB access monitoring apparatus and a verification apparatus in the present embodiment;

FIG. 11 is a block diagram showing functions of the DB access monitoring apparatus in the present embodiment;

FIG. 12 is a flowchart of a process performed in the DB access monitoring apparatus in the present embodiment; and

FIG. 13 is a diagram for illustrating features of operations of the DB access monitoring apparatus in the present embodiment.

### BEST MODE FOR CARRYING OUT THE INVENTION

The preferred embodiment of the present invention will now be described in detail with reference to the accompanying drawings.

In the present invention, when a request for searching a database (hereinafter referred to as a “DB”) storing personal information is issued by a DB user (hereinafter referred to as an “agent”), a small piece of information such as dummy personal information is mixed into the result of the search and provided to the agent together with the search result. In doing so, information as to which agent the dummy personal information has been provided is recorded. Thus, if a contact address indicated by dummy personal information is subsequently contacted, it can be assumed that personal information has been leaked, and an agent that may have leaked the information can be identified.

Two models in which a customer database is searched and to which the present embodiment is applied will be described below.

In a first model, an agent likely to have leaked customer data is identified if direct mail (hereinafter referred to as a “DM”) is sent based on customer data leaked from a customer DB.

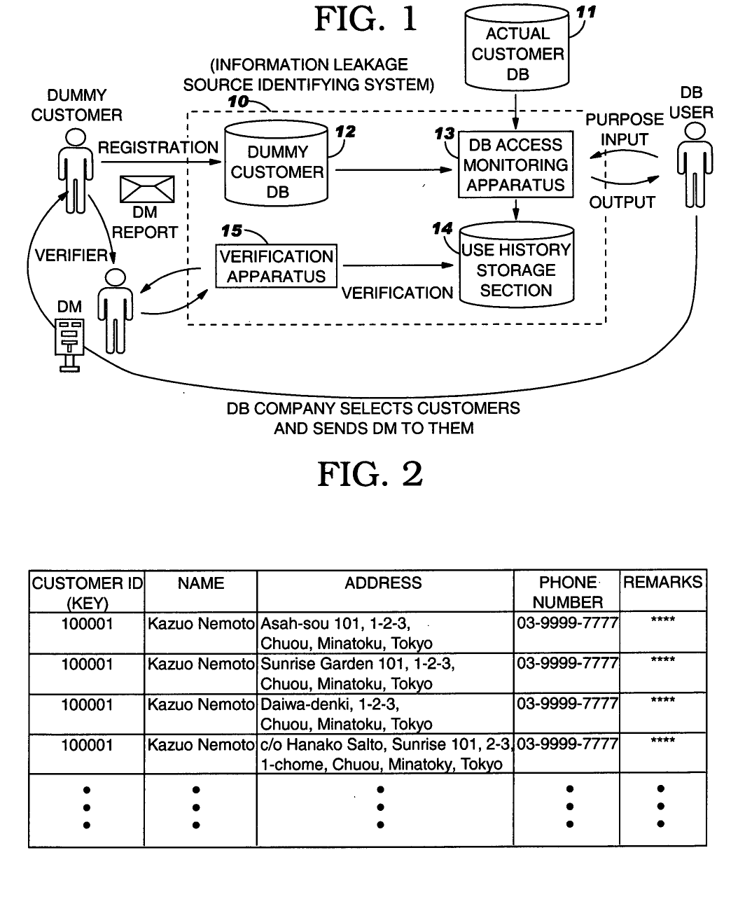

As shown in FIG. 1, there is a customer DB 11 storing actual customer data as a source of inputs to an information leakage source identifying system 10. Customer data herein is valid data retained by the company at which the information leakage source identifying system 10 is provided. The actual customer data may include IDs, names, addresses, telephone numbers, and other profile information of customers.

The information leakage source identifying system 10 also include a dummy customer DB 12, a DB access monitoring apparatus 13, a use history storing section 14, and a verification apparatus 15.

The dummy customer DB 12 stores dummy data in the same format as that of the actual customer data. FIG. 2 shows an example of data stored in the dummy customer DB 12. In this example, it is assumed that the dummy data is for dummy customers, not actual customers. The customer ID “100001” shown in FIG. 2 is an ID that is reserved for a dummy customer and is not used for an actual customer. A dummy customer may be an employee of any company that operates the information leakage source identifying system 10. Alternatively, if a service provider that provides a data center solution maintaining the whole customer roster is operating the information leakage source identifying system 10, the provider may provide a dummy customer as well.

A number of variations of dummy data are provided for the same customer data as shown in FIG. 2.

In particular, slight changes are made to names and/or addresses of a dummy customer in this model (such slight changes are referred to as variants hereinafter). The purpose of this is to identify an agent that has leaked customer data including data concerning the dummy customer by using a name and/or address written in DM sent to the dummy customer as a clue. Because it is required that the DM be delivered to the dummy customer, changes in the name and/or address must be slight to preclude a possibility of misdelivery.

To make a variant to a name, the first name written in Kanji may be changed to a name written in Hiragana or one Kanji character in the first name may be changed to a homophone or different Kanji character having the same pronunciation, with the last name unchanged. While the exemplary names written in Japanese are shown in FIG. 2, changes may be made to names in English by using synonyms, such as replacing “Alex” with “Alexander.”

To make a variant to an address, a style or an in-care-of name may be slightly changed or added. Because styles and in-care-of names for private use are not contained in resident cards, mail can be delivered even if changes are made to them.

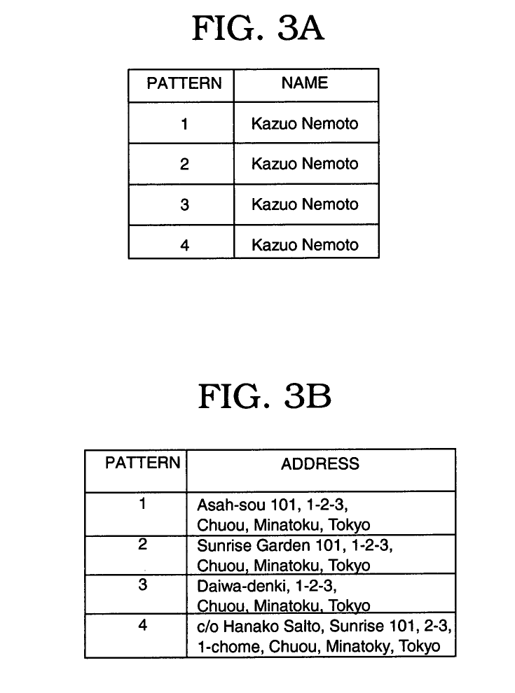

Variants may be made to names and/or addresses manually. However, such operations would require a large number of man-hours for creating many variations for each dummy customer. Therefore, several patterns may be provided for each of the name and address of a dummy customer as shown in FIG. 3, and these patterns may be combined to form dummy data.

For example, four patterns are provided for the name as shown in FIG. 3(a) and four patterns are provided for the address as shown in FIG. 3 (b). The four patterns manually created for each of the name and address allows 16 (=4×4) dummy data items to be generated automatically. If 100 patterns are provided for each of the name and the address, ten thousand (=100×100) dummy data items can be generated.

The first, second, third, and fourth rows in FIG. 2 correspond to the combination of pattern 1 in FIG. 3(a) and pattern 1 in FIG. 3(b), the combination of pattern 2 in FIG. 3(a) and pattern 2 in FIG. 3(b), the combination of pattern 3 in FIG. 3(a) and pattern 3 in FIG. 3(b), and the combination of pattern 4 in FIG. 3(a) and pattern 4 in FIG. 3(b), respectively.

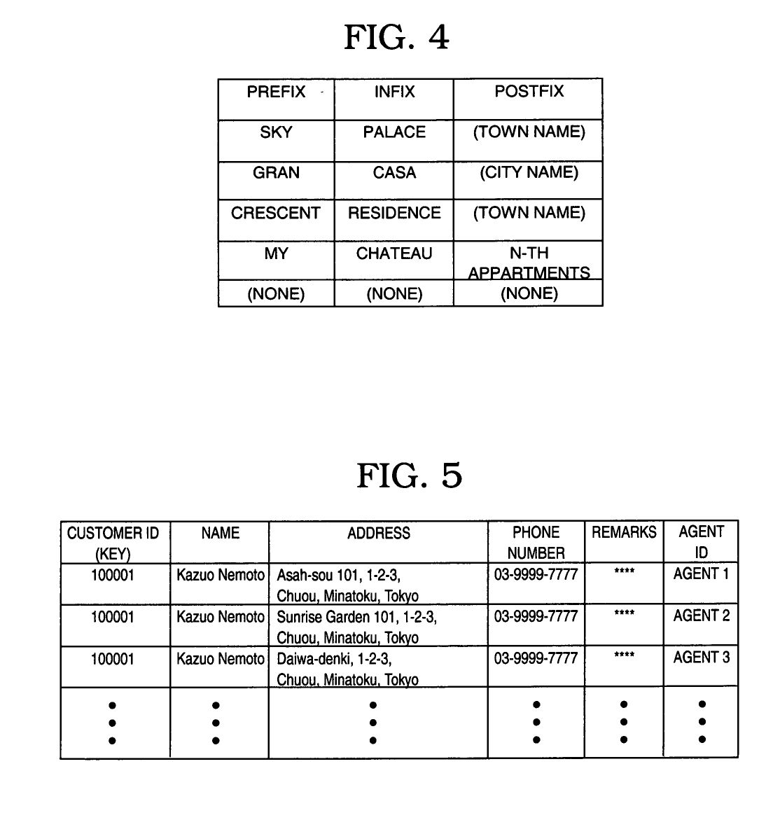

Changes to a portion of an address, such as a style, as shown in FIG. 3(b) may be made manually or with software for automatically generating styles and the like (automatic style generator). In the latter case, words that can be used in styles are defined and classified as a prefix, infix, and postfix as shown in FIG. 4 and combined appropriately to generate styles and the like. In this example, apartment names such as “My Residence Shimokitazawa,” “Gran Casa Third Apartments,” and “Crescent Palace” can be automatically generated by using the automatic style generator.

It is assumed that dummy data has been provided in the dummy customer DB 12 as described above, and an agent inputs an agent ID and intended use, etc. and requests a search for customer data. Then, the DB access monitoring apparatus 13 mixes a small amount of dummy data into the actual customer data found in the actual customer DB 11 and provides it to the agent. In particular, a dummy customer associated with profile information that matches the search criteria specified by the agent is identified and one variation created for that dummy customer is selected and mixed into the data. That is, when a list command such as “SELECT * FROM USERTABLE” in SQL statements is received, a different variation is displayed for each search request. Thus, slightly different data can be provided with the same total quantity of data and the same keys.

At the same time, the DB access monitoring apparatus 13 stores in the use history storing section 14 a history indicating which dummy data has been provided to which agent. FIG. 5 shows an example of data stored in the use history storing section 14. In the example shown in FIG. 5, the dummy data items in the first, second, and third rows in FIG. 2 are provided to agents associated with agent IDs “agent 1,” “agent 2,” and “agent 3,” respectively. In addition to the data shown in FIG. 5, other information such as the date on which each dummy data item has been output and the ID of a terminal device used for outputting the data may also be contained in the use history storing section 14.

It is assumed that the agent illegally obtained customer data including a slight amount of dummy data provides the data illegally to a DM company, which in turn selects customers from the customer roster data provided and sends DM to those customers. As a result, when the DM is delivered to a dummy customer, the dummy customer notifies a human verifier of the delivery of the DM. The verifier then uses the verification apparatus 15 to check the data in the use history storing section 14 to identify the agent ID of the agent who leaked the customer data.

In a second model, an agent likely to have leaked customer data is identified if a canvassing call based on customer data leaked from a customer DB is received. Nowadays, DM marketing is being replaced with telemarketing as the mainstream marketing tool. The model in which a canvassing call is used as a trigger to identify an information leakage source addresses this trend.

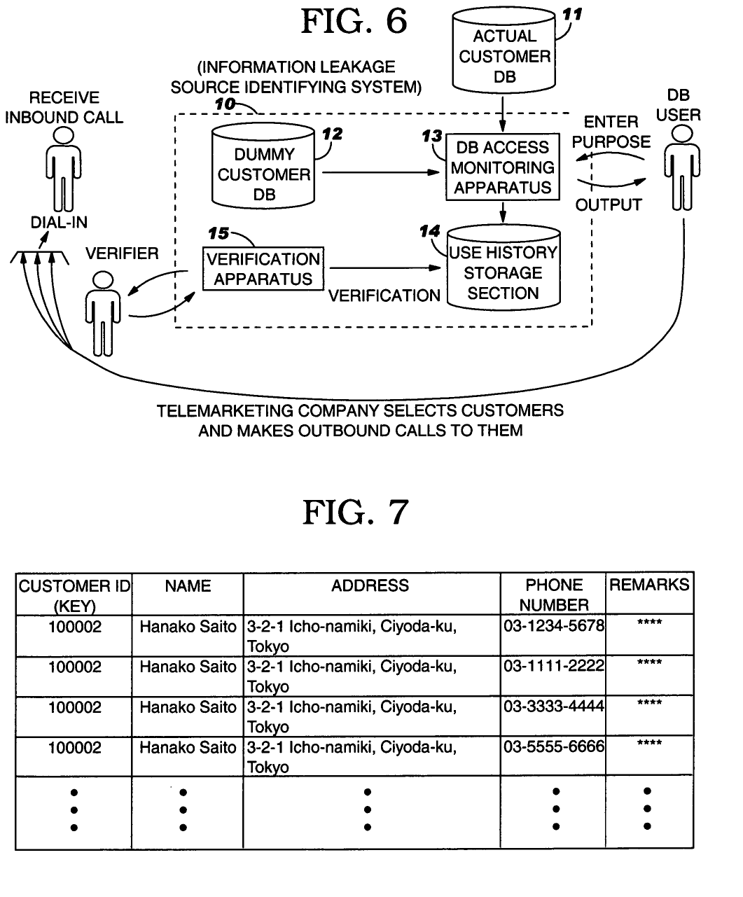

In FIG. 6, as in FIG. 1, there is an actual customer DB 11 storing actual customer data as a source of input to an information leakage source identifying system 10. Actual customer data therein is true customer data retained by the company using the information leakage source identifying system 10. The actual customer data may include IDs, names, addresses, telephone number, and other profile information of customers.

The information leakage source identifying system 10 includes a dummy customer DB12, a DB access monitoring apparatus 13, a use history storing section 14, and a verification apparatus 15.

The dummy customer DB 12 stores dummy data in the same format as that of the actual customer data. FIG. 7 shows an example of data stored in the dummy customer DB 12. In this example, it is assumed that the dummy data is on other than actual customers. The customer ID “100002” shown in FIG. 7 is an ID that is reserved for a dummy customer and is not used for an actual customer. A dummy customer may be an employee of any company that is operating the information leakage source identifying system 10. Alternatively, if a service provider is operating the information leakage source identifying system 10, the provider may provide a dummy customer as well.

A number of variations of dummy data are provided for the same customer data as shown in FIG. 7. In particular, different telephone numbers are provided for a dummy customer in this model. Unlike the first model, the second model uses telephone numbers actually obtained, rather than providing a variant to a telephone number. While changes are made to an address to provide variants and the variants are reused in the first model because addresses are expensive resources and the operation costs per dummy customer would otherwise become expensive, such reuse is not required in the second model because telephone numbers can be obtained at a significantly lower cost.

The association between individuals and their addresses is a close one-to-one relationship and could remain ten years or so, whereas the association between an individual and phone numbers is typically a loose relationship such as one-to-three. For example, individuals may have their office and home telephone numbers. Furthermore, many people today have a cellular phone. Some people have more than one cellular phone or may change their telephone numbers every two years or so. Therefore, providing different telephone numbers for each dummy customer is a natural way to make this system difficult to uncover.

In this model, an environment is built in which the “Dial-In Service” provided by Nippon Telegraph and Telephone East Corporation, for example, is used for all calls to telephone numbers set as dummy data so that they can be answered in one site. The Dial-In Service can be used at a cost as low as 800 Yen per number and per month as of Jan. 15, 2004, which is lower than the case where dummy customers are actually deployed.

Such a centralized arrangement for answering all calls means that dummy customers are virtualized, rather than being associated with actual people. If dummy customers are actually deployed as in the first model, they would be involved in the secret because they are part of this system, even though they do not know the entire system. Another problem is whether the privacy of dummy customers is ensured. The second model, in contrast, can be used to avoid this problem. The second model virtualizes dummy customers as described above and imaginary addresses are written as their addresses.

It is assumed here that dummy data has been provided in the dummy customer DB 12 as described above and an agent inputs an agent ID and intended use and requests a search for customer data. Then, the DB access monitoring apparatus 13 mixes a small amount of dummy data into the actual customer data found in the actual customer DB 11 and provides it to the agent. In particular, a dummy customer associated with profile information that matches the search criteria specified by the agent is identified and one of the variations created for that dummy customer is selected and mixed into the data. That is, when a list command such as “SELECT * FROM USERTABLE” in SQL statements is received, a different variation is displayed for each search request. Thus, slightly different data can be provided with the same total quantity of data and the same keys.

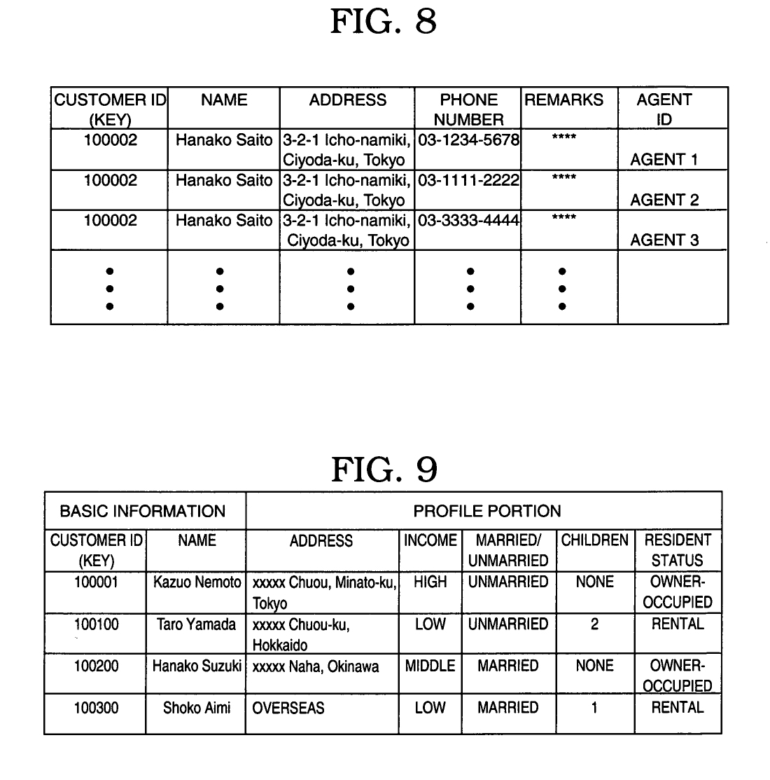

At the same time, the DB access monitoring apparatus 13 stores in the use history storing section 14 a history indicating which dummy data has been provided to which agent. FIG. 8 shows an example of data stored in the use history storing section 14. In the example shown in FIG. 8, the dummy data items in the first, second, and third rows in FIG. 7 are provided to agents associated with agent IDs “agent 1,” “agent 2,” and “agent 3,” respectively. In addition to the data shown in FIG. 8, other information such as the date on which each dummy data item has been output and the ID of a terminal device used for outputting the data may also be contained in the use history storing section 14.

It is assumed that the agent illegally obtaining customer data with dummy data provides the data illegally to a telemarketing company, which selects customers from the customer roster data provided. Then a telemarketing staff member makes outbound calls to the customers. As a result, a canvassing call to a dummy customer is captured through the Dial-In service and transferred to the monitoring room.

A male investigator and a female investigator are waiting in the monitoring room for answering calls. For example, the following conversation is possible.

Telemarketing staff member: Is this the Saito's?
Leakage investigator (male): Yes.
Telemarketing staff member: Could I speak to Hanako?
Leakage investigator (male): Hold on please.
At this point, the female investigator takes the call.
Leakage investigator (female): Hanako speaking.

Fact-finding may end here. However, the investigator may carry on the conversation to elicit information about the telemarketing company.

The conversation is recorded as a telephone record. Information indicating which telephone number the call has been made to is also recorded. If the call made to the number “03-1234-5678” is recorded in the above-described example, the record indicating that the call to Hanako Saito has been made with the telephone number 03-1234-5678 can be used as important evidence. A verifier uses the verification apparatus 15 to check the data in the use history storing section 14 and identify the agent ID of the agent that caused the leakage of customer data.

The quality of address of agents at a call center is typically monitored by a supervisor. The supervisor may act as a leak investigator described above, thereby saving labor costs.

In the foregoing description, the first model and the second model have been described separately. However, DM-type dummy data and telephone-type dummy data can be used in combination. Such an implementation is best to prevent dummy data from being excluded. That is, in such an implementation, if one sends DM to every customer and tries to exclude dummy customers, names and addresses contained in the DM would reveal the personal information leakage source. On the other hand, if one makes a phone call to every customer to check whether or not the customer actually exist, the call is connected to a monitor room and the personal information leakage source is identified.

It should be noted that if a name consolidation system is used when implementing these models, dummy data must be mixed after the name consolidation process is performed. This is because if a number of customer DBs are consolidated to generate the actual customer DB 11, variations in the dummy data would be integrated into one entry. Dummy data should be added after the process by the name consolidation system is completed so that the data appears to an agent as if variations of addresses were produced as a result of name consolidation and thereby prevent the agent from being suspicious about the operation of the system.

It is desirable that profiles (including personal attributes) in dummy data included in customer data in these models be intentionally dispersed as shown in FIG. 9. This allows dummy data to always remain in customer data after screening by any agent, which is the leakage source of the customer data, targeting any region. In the example in FIG. 9, dummy data is dispersed in terms of address, income, marriage, children, and resident status profiles. Therefore, any of the dummy customers will be contacted by any agent in any business category such as marriage brokerage, funeral, consumer loan settlement service, and private preparatory school businesses.

The DB access monitoring apparatus 13, which is a core component of the system 10 will be described below in detail.

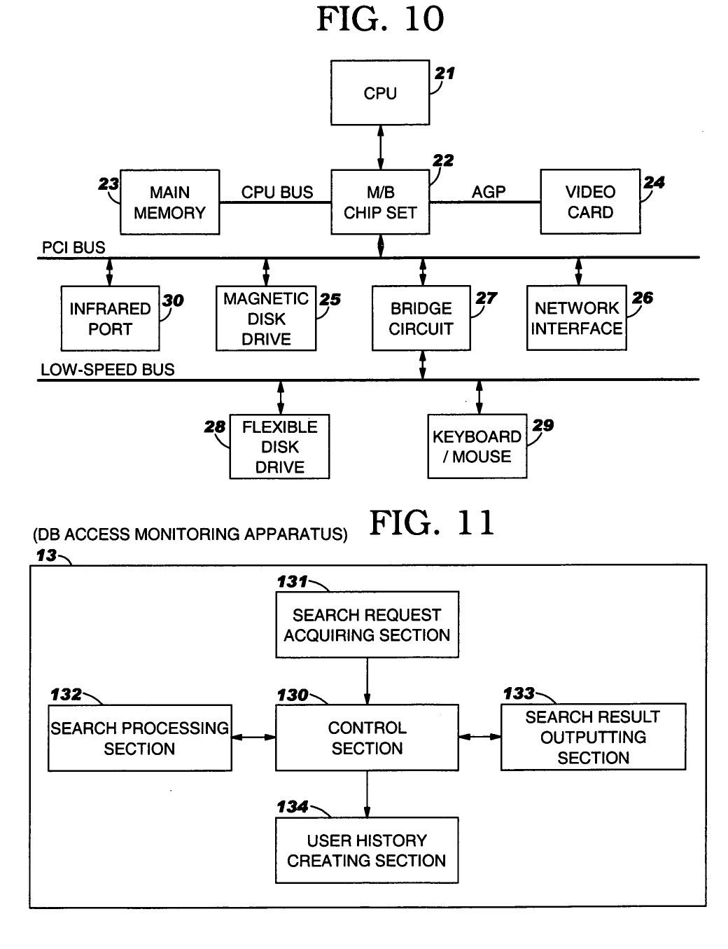

FIG. 10 schematically shows an exemplary hardware configuration of a computer suitable for implementing the DB access monitoring apparatus 13. The computer shown in FIG. 10 includes a CPU (Central Processing Unit) 21 which is calculating means, a main memory 23 connected to the CPU 21 through an M/B (mother board) chip set 22 and a CPU bus, a video card 24 also connected to the CPU 21 through the M/B chip set 22 and an AGP (Accelerated Graphics Port), a magnetic disk drive (HDD) 25, a network interface 26, and an infrared port 30 for providing infrared communication with other apparatuses, which are connected to the M/B chip set 22 through a PCI (Peripheral Component Interconnect) bus, and a flexible disk drive 28 and a keyboard/mouse 29, which are connected to the M/B chip set 22 through the PCI bus, a bridge circuit 27 and a low-speed bus such as an ISA (Industry Standard Architecture) bus.

The configuration in FIG. 10 is shown as one example of a hardware configuration of a computer implementing the present embodiment. Any other configuration to which the present invention can be applied may be used. For example, only a video memory may be provided in place of the video card 24 and image data may be processed on the CPU 21. A CD-R (Compact Disc Recordable) drive or DVD-RAM (Digital Versatile Disc Random Access Memory) drive may be provided as an external storage through an interface such as an ATA (AT Attachment) or a SCSI (Small Computer System Interface).

The magnetic disk drive 25 stores a computer program for implementing the functions in the present embodiment. The CPU 21 executes this program by reading it at a main memory 23 to performs the functions of the present embodiment, which will be described later. The computer program may be stored in the magnetic disk drive 25 before the shipment of the system or may be installed in the magnetic disk drive 25 by a user after the shipment of the system. The program may be installed by downloading the program from a server computer through cable or wireless communication or from a recording medium such as a CD-ROM.

As shown in FIG. 11, the DB access monitoring apparatus 13 includes a control section 130, a search request acquiring section 131, a search processing section 132, a search result outputting section 133, and a use history creating section 134.

The control section 130 controls the search request acquiring section 131, search processing section 132, search result outputting section 133, and use history creating section 134.

The search request acquiring section 131 acquires a DB search request including an agent ID.

The search processing section 132 searches the actual customer DB 11, dummy customer DB 12, and use history storing section 14 to generate a search result including dummy data.

The search result outputting section 133 provides a search result including dummy data to an agent.

The use history creating section 134 creates a history indicating which dummy data has been provided to which agent and outputs it to the use history storing section 14.

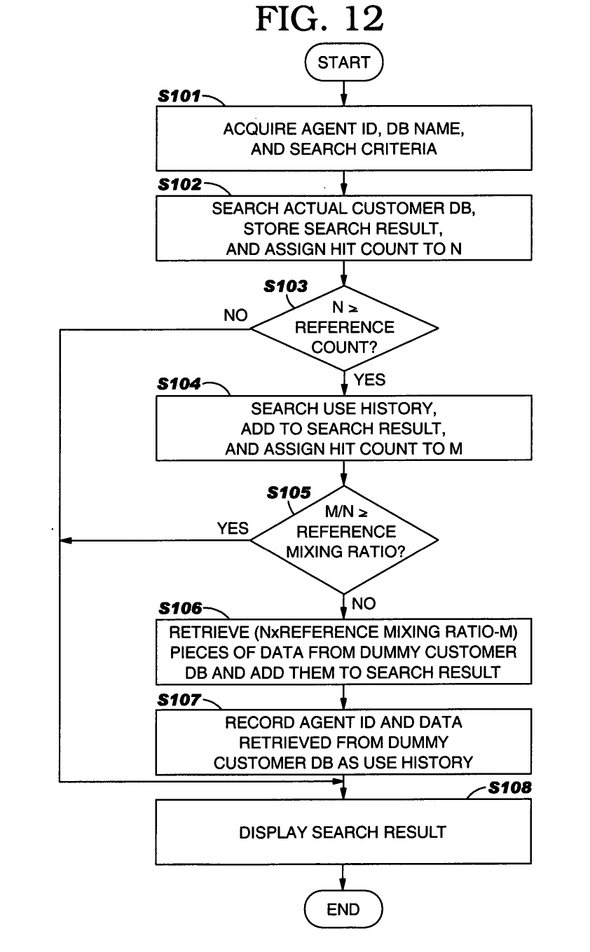

Referring to FIG. 12, operations of the present embodiment will be detailed below. First, the search request acquiring section 131 acquires a search request including an agent ID, DB name, and search criteria and provides it to the control section 130 (step 101). Then, the control section 130 directs the search processing section 132 to search through for customer data using the agent ID, DB name, and search criteria as parameters.

When receiving this direction, the search processing section 132 first searches the actual customer DB 11. It then stores the result of the search and assigns the number of hits to N (step 102).

The search processing section 132 determines whether or not N is greater than or equal to a preset reference value (step 103). If not, the search processing section 132 displays the search result as is (step 108). On the other hand, if N is greater than or equal to the reference value, the process proceeds to a step for mixing dummy data into customer data. The purpose of making this determination is to prevent the search from responding to a minor extraction operation, thereby minimizing the visibility of dummy data (make the inclusion of dummy data unnoticed).

If dummy data is to be included, the search processing section 132 searches the use history storing section 14 and inputs the result of the search into the search result storage area on the memory and assigns the number of hits to M (step 102).

The following search methods can be used.

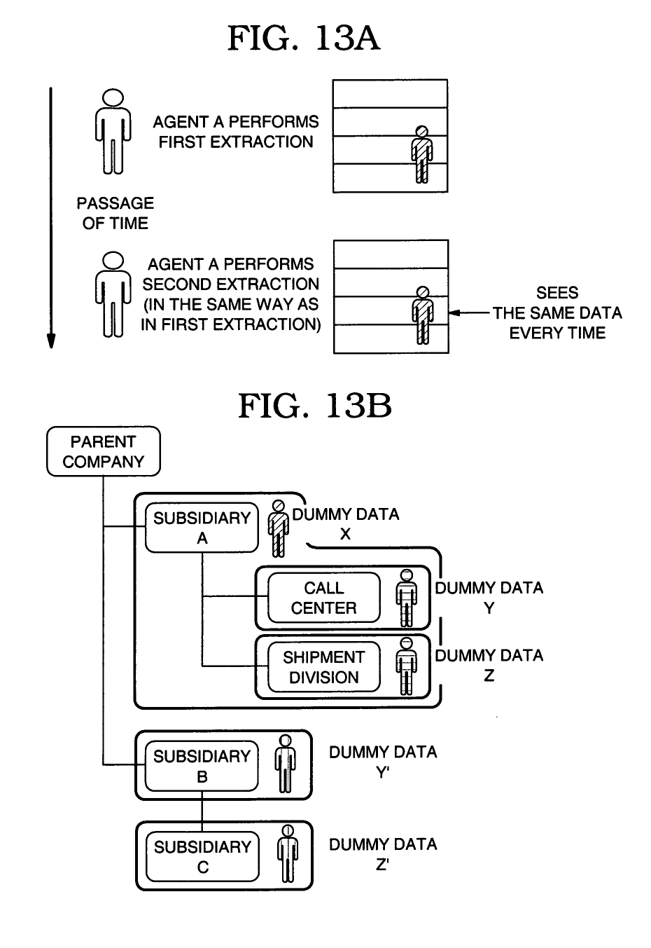

A first method is to search the dummy data stored in the use history storing section 14 for dummy data that matches the search criteria among dummy data associated with the agent ID provided from the control section 130. FIG. 13(a) shows the concept of this search method. According to this search method, if a particular agent performs searches with the same search criteria at different times, the same dummy data is seen by that agent.

A second search method is to search the dummy data stored in the use history storing section 14, for dummy data that matches the search criteria among dummy data associated with the agent ID provided from the control section 130 or another agent ID whose relationship with the agent ID provided from the control section 14 is predefined. FIG. 13(b) shows the concept of this method.

If a parent company has outsourced the task of managing a roster to its subsidiaries A, B, and C, and if employees of subsidiary A show each other the results of searches separately performed with the same search criteria, they may identify dummy data. Therefore, if data about dummy customer X is to be presented to employees of subsidiary A, the same dummy data X is presented to them.

Also, if staff members of the call center of subsidiary A show each other the results of searches separately performed with the same search criteria, they may identify dummy data. Therefore, if data about dummy customer Y is to be presented to employees of subsidiary A, the same dummy data Y is presented to them. On the other hand, a staff member of the call center of subsidiary A and an employee of subsidiary B are unlikely to show each other the results of searches performed with the same search criteria. Therefore, dummy data Y is presented to the employee of the subsidiary B as dummy data Y′. The same applies to the case of subsidiaries A and C.

In performing searches as described above, the search processing section 132 determines whether or not (M/N) exceeds a preset reference mixing ratio (step 105). If (M/N) is greater than or equal to the reference mixing ratio, the search processing section 132 presents the result of a search as-is (step 108). If not, it proceeds to the step of including dummy data. The purpose of making the determination as to whether (M/N) is greater than or equal to the reference mixing ratio is to achieve a desired object without including an excessive amount of dummy data. In past personal information leakage cases, the minimum unit of data leaked is 1,000 customer records. Therefore, the object can be achieved with a reference mixing ratio of (1/1,000).

If more dummy data is to be included, the search processing section 132 searches the dummy customer DB 12 and adds the result of the search into the search result storage area on the memory (step 106). Here, it is required that dummy data be added until the reference mixing ratio is reached. Accordingly, (N×reference mixing ratio−M) dummy data items are retrieved. For each customer ID that is determined to be included as dummy data, one variation of data that has not yet been used is selected from plural variations created in advance and included into the search result.

Then, the search processing section 132 returns the search result including the dummy data to the control section 130.

On the other hand, the control section 130 provides the agent ID and the dummy data in the search result storage area to the use history creating section 134, which in turn associates the agent ID with the dummy data to create a use history and outputs it to the use history storing section 14 (step 107).

The control section 130 provides the search result including the dummy data to the search result outputting section 133, which displays the search result on the display of a terminal apparatus used by the agent (step 108).

This completes the operation performed in the DB access monitoring apparatus 13 according to the present embodiment.

In the above-described operation, the following features have been used in including dummy data in the search result.

(A) The ratio of dummy data in the search result (mixing ratio) is maintained at a predetermined value.

(B) Dummy data is added if the number data items included in the search result is greater than or equal to a predetermined value.

(C) Even if a particular agent performs searches with the same criteria at different times, the same dummy data is seen by the agent.

(D) Even if different agents belonging to a particular organization performs searches with the same criteria, the same dummy data is seen by them.

Each of these features makes sense by itself. Therefore, it is not necessary to implement all of the features. The operation shown in FIG. 12 is an exemplary operation of the DB access monitoring apparatus 13. The DB access monitoring apparatus 13 can perform any operation for implementing these features.

As the use history, associations between agent IDs and identifications of dummy data may be recorded instead of associations between agent IDs and dummy data itself. Dummy data identifications used herein are variation IDs that uniquely identify a plurality of variations created for a dummy customer, rather than customer IDs that uniquely identify dummy customers.

According to the concept described with reference to FIG. 13(b), the same telephone number may be used for groups such as the call center of subsidiary A and subsidiary B that are unlikely to conspire with each other.

A hardware configuration of a computer suitable for implementing the verification apparatus 15, which is another core component of the information leakage source identifying system 10, is similar to the one shown in FIG. 10.

A magnetic disk drive 25 in the verification apparatus 15 also stores a computer program for implementing the functions of the present embodiment. A CPU 21 reads the computer program into a main memory 23 and executes it to implement the functions of the present embodiment. The computer program may be stored in the magnetic disk drive 25 before the system is shipped or may be installed by a use into the magnetic disk drive 25 after the system is shipped. The program may be installed by downloading from a server computer through cable or wireless communication or from a recording medium such as a CD-ROM.

The functions of the verification apparatus 15 include the functions of receiving information such as the names, addresses, and telephone numbers of dummy customers from a human verifier, searching the use history storing section 14 for identifying an agent ID based on the received information, and presenting the agent ID to the verifier.

Dummy customers are deployed in the embodiment described above. This approach is especially advantageous for a company providing a service as a data center solution because it can convince its user companies that security is high, thereby improving the value of the service. However, the roll of a dummy customer may be assigned to an actual customer with prior consent. In that case, an element such as “stored procedure” may be include in the last section of the SELECT statement in SQL so that if data about the actual customer who has given the consent is retrieved, the name and/or address or telephone number of the customer is automatically changed according to a predetermined set of rules.

As has been described, dummy data is included in the result of a database search and an association between the agent ID who has performed the search and the dummy data is recorded in the present embodiment. Therefore, if personal information is leaked out, the source of leakage can be identified.

Although the present invention has been described with respect to a specific preferred embodiment thereof, various changes and modifications may be suggested to one skilled in the art and it is intended that the present invention encompass such changes and modifications as fall within the scope of the appended claims.

1. A database access monitoring apparatus, comprising:
a search request acquiring section to search a database together with information identifying a search requester;
a search processing section for searching the database based on the search request acquired by the search request acquiring section as well as mixing dummy data into the search result;
a use history creating section for creating information indicating a relationship between the information identifying the search requester which has been acquired by the search request acquiring section and the dummy data mixed into the search result by the search processing section; and
a search result outputting section for outputting to the search requester the search result into which the dummy data has been mixed by the search processing section.

2. The database access monitoring apparatus according to claim 1, wherein the search processing section mixes the dummy data into the search result at a predetermined ratio to the total number of data items in the search result.

3. The database access monitoring apparatus according to claim 1, wherein the search processing section mixes the dummy data into the search result if the total number of data items in the search result exceeds a predetermined value.

4. The database access monitoring apparatus according to claim 1, wherein the search processing section mixes the same dummy data into results of searches performed in response to related searches from the same search requester.

5. The database access monitoring apparatus according to claim 1, wherein the search processing section mixes the same dummy data into results of searches performed in response to search requests from different search requesters, wherein a relationship between said different search requesters has been predefined.

6. The database access monitoring apparatus according to claim 1, wherein the search processing section adds one of a plurality of dummy data items created by changing a name and/or address of a dummy person without affecting mail delivery to said dummy person.

7. The database access monitoring apparatus according to claim 6, wherein the search processing section adds one of said plurality of dummy data items created by changing a telephone number of said dummy person.

8. The database access monitoring apparatus according to claim 7, wherein the search processing section adds one of said plurality of dummy data items comprising a combination of dummy data generated by changing said name and/or address of said dummy person and one of said plurality of dummy data items generated by changing said telephone number of said dummy person.

9. The database access monitoring apparatus according to claim 1, wherein the search processing section adds one of said plurality of dummy data items having different profile information.

10. A database access monitoring method for a computer to monitor access to a database, comprising the steps of:
acquiring a request to search the database together with information identifying a search requester;
searching the database based on said search request;
mixing dummy data into a result of searching the database;
storing information indicating a relationship between said information identifying said search requester and said dummy data mixed into the search result; and
outputting to said search requester said search result in which said dummy data is mixed.

11. A computer program product for causing a computer to realize functions of:
acquiring a request to search a database together with information identifying a search requester;
searching the database based on said acquired search request;
mixing dummy data into a search result; and
creating information indicating a relationship between said information identifying said search requester and said dummy data mixed into said search result.

12. The program product of claim 11, wherein said function of mixing combines said dummy data into said search result at a predetermined ratio to a total number of data items in said search result.

13. The program product of claim 11, wherein said function of mixing combines a same one of said dummy data into results of searches performed in response to search requests from a same search requester.

14. The program product of claim 11, wherein said function of mixing combines a same one of said dummy data into said results of searches performed in response to search requests from different search requesters, wherein a relationship between said different search requesters has been predefined.

15. The program product of claim 11, wherein said function of mixing mixes combines said dummy data into said search result by applying particular data included in said search result in accordance with a predefined set of rules to generate said dummy data.
